(19) United States
(12) Patent Application Publication
(10) Pub. No.: US 2004/0218630 A1
(43) Pub. Date: Nov. 4, 2004

(54) Wireless-compatible MAC frame transmitting/receiving method and apparatus

(75) Inventor: Cheol-hong An, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/836,404

(22) Filed: May 3, 2004

Related U.S. Application Data
(60) Provisional application No. 60/490,901, filed on Jul. 30, 2003.

(30) Foreign Application Priority Data
May 3, 2003 (KR) 10-2003-0028427

(51) Int. Cl. H04J 3/16

(52) U.S. Cl. 370/470; 370/465

(57) ABSTRACT

A method and apparatus capable of maximizing data throughput by using information on the maximum MAC frame size supported by a physical layer under the existing wireless network environment and by determining the maximum MAC service data unit (MSDU) among network devices. An apparatus of the present invention includes a MAC SAP for providing a service of transmission/reception of data between an upper protocol layer and a MAC layer; a MLME SAP for providing a service of transmission/reception of a packet between the apparatus and another network node; a packetizer module for creating a frame conforming to a MAC frame format by using data received from the upper protocol layer; and a MSDU negotiation module for storing the maximum MSDU size and MAC address of the network node obtained through the management packet and controlling a fragmentation threshold according to the state of a channel.

This application claims the priority of Korean Patent Application No. 10-2003-0028427 filed on May 3, 2003, in the Korean Intellectual Property Office, and U.S. Provisional Patent Application No. 60/490,901 filed on Jul. 30, 2003, with the United States Patent and Trademark Office, the disclosures of which are incorporated herein in their entireties by reference.

### BACKGROUND OF THE INVENTION

1. Field of Invention

Apparatuses and methods consistent with the present invention relate to increasing data throughput in transmission/reception of data among network devices on a network. More particularly, the present invention relates to a method and apparatus capable of maximizing data throughput by using information on the maximum Media Access Control (MAC) frame size supported by a physical layer under the existing wireless network environment and by determining the maximum MAC service data unit (MSDU) among network devices.

2. Description of the Related Art

In existing network communications, the MAC Layer Frame Size is fixed for every standard. This causes a problem in that a MAC frame cannot be efficiently transmitted due to the use of the fixed size of frame in a MAC layer without considering the maximum size that can be sent by a physical layer.

For IEEE 802.11, the maximum MSDU size of a frame of a MAC layer is fixed at 2304 bytes. As shown in FIG. 1, in a frame body, the maximum MSDU size is 2312 bytes, which is the sum of 4 bytes of initialization vector (IV), 2304 bytes of contents and 4 bytes of integrity check value (ICV), and the maximum MAC protocol data unit (MPDU) is 2336 bytes.

However, it is possible to transmit a MPDU of 4095 bytes in a physical layer that uses a frequency-hopping spread spectrum method. Here, the frequency-hopping spread spectrum method is one of spectrum spreading methods such as direct sequence spread spectrum (DSSS), by which transmission is made by changing the frequency with time without fixing the frequency, i.e., communications are made by changing the frequency at sending and receiving parts.

A physical layer using the DSSS method can maximally transmit a MPDU of 8191 bytes. A physical layer using an infrared method can transmit a MPDU of 2500 bytes. Physical layers of IEEE 802.11a and IEEE 802.11b can transmit a MPDU of up to 4095 bytes. In ultra-wide band (UWB), it is possible to transmit a slightly larger MAC frame.

As shown in FIG. 2, a MAC frame, i.e. MPDU, creates a PLCP Protocol Data Unit (PPDU) by combining a physical layer convergence protocol (PLCP) preamble and a PLCP header at PLCP of a physical layer. Thus, overhead will increase and entire throughput will be lowered as frame size gets smaller due to the large preamble and header required by the physical layer in each frame, the wide frame space between respective frames and the long channel acquisition time in UWB.

As shown in FIG. 3, inter frame spaces (IFSs) are required to transmit a single frame and an Acknowledgement Code (ACK) packet for each frame may also exist. This prevents the transmission of the largest frame possible, thereby causing throughput to be decreased due to increases in the numbers of unnecessary IFSs and ACK frames, MAC headers, PLCP preambles and PLCP headers.

Today, digital products such as DVD players, Cable STBs, DVCRs, DTVs are frequently used due to the development and spread of digital media. Moreover, under an environment in which such products are connected to wireless networks, audio/video (AV) streams and various data are transmitted within limited wireless network bandwidths. Therefore, there is a need for an improvement of throughput in such a wireless environment.

### SUMMARY OF THE INVENTION

The present invention is conceived to solve these problems. An aspect of the present invention is to provide a method of maximizing throughput by using information on the maximum MAC frame size supported by a physical layer under an existing wireless network environment and determining the maximum MSDU size of the MAC frame size through negotiation between network devices.

Another aspect of the present invention is to provide a method of modifying the maximum MSDU size to be used according to a channel state upon use of the information on the maximum MAC frame size supported by the physical layer and determination of the maximum MSDU size through the negotiation between the network devices.

According to an aspect of the present invention, there is provided a MAC frame managing apparatus which stores the maximum MSDU size and destination MAC address of the other network node obtained through a management packet and controls the MAC frame size by adjusting a fragmentation threshold value according to the state of a transmitting/receiving channel which is determined by comparing a failure rate of a transmitted frame with the receiving signal strength of the packet received by a physical layer.

According to another aspect of the present invention, there is provided a wireless-compatible MAC frame transmitting apparatus, comprising a MAC Service Access Point (SAP) for providing a service of transmission/reception of data between an upper protocol layer and a MAC layer; a MAC Layer Management Entity (MLME) SAP for providing a service of transmission/reception of a packet between the apparatus and the other network node; a packetizer module for creating a frame conforming to a MAC frame format by using data received from the upper protocol layer; and a MSDU negotiation module for storing the maximum MSDU size and MAC address of the network node obtained through the management packet and controlling a fragmentation threshold according to the state of a channel.

According to a further aspect of the present invention, there is provided a wireless-compatible MAC frame receiving apparatus, comprising a depacketizer module for removing a header created in a MAC layer; a MAC SAP for providing a service of transmission/reception of data between an upper protocol layer and the MAC layer; a MLME SAP for providing a service of transmission/reception of a packet between the apparatus and the other network node; and a MSDU negotiation module for determining the MSDU size of the other network node through the received management packet and transmitting information on its own MSDU size by using a management packet.

According to a still further aspect of the present invention, there is provided a wireless-compatible MAC frame transmitting method, comprising the steps of broadcasting, by a sending part, its own maximum MSDU size by using a management frame; receiving a management frame containing information on the maximum MSDU size from a network node that responds to the broadcast; extracting a MAC address and maximum MSDU size information of the network node from the received management frame and storing them in a destination list; comparing its own maximum MSDU size with the maximum MSDU size of the network node stored in the destination list and determining which maximum MSDU size is larger; and transmitting a MAC frame according to the determination results.

According to a still further aspect of the present invention, there is provided a wireless-compatible MAC frame receiving method, comprising the steps of receiving, by a sending part, a broadcast frame from the other network node and storing the maximum MSDU size and MAC address of the network node in a destination list; transmitting a management frame with information on its own maximum MSDU size to the network node; and receiving a MAC frame from the network node.

### BRIEF DESCRIPTION OF THE DRAWINGS

The above and other aspects and features of the present invention will become apparent from the following description of exemplary embodiments given in conjunction with the accompanying drawings, in which:

FIG. 1 is a schematic diagram illustrating a structure of a MAC frame of IEEE 802.11;

FIG. 2 is a schematic diagram illustrating a structure of a PLCP frame of IEEE 802.11;

FIG. 3 shows the structures of a directed frame, ACK and IFSs of IEEE 802.11;

FIG. 4 is a block diagram showing a configuration of a MAC in a transmitting apparatus according to the present invention;

FIG. 5 is a block diagram showing a configuration of a MAC in a receiving apparatus according to the present invention;

FIG. 6 is a flowchart illustrating an operation of the transmitting apparatus according to the present invention; and

FIG. 7 is a flowchart illustrating an operation of the receiving apparatus according to the present invention.

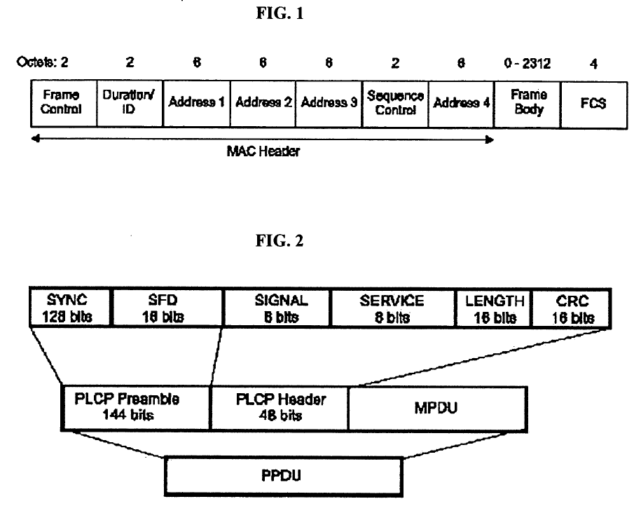

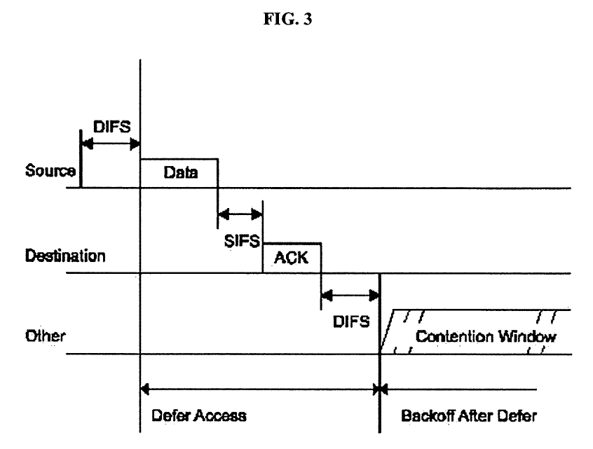

### DETAILED DESCRIPTION OF THE INVENTION

Hereinafter, embodiments of the present invention will be described in detail with reference to the accompanying drawings.

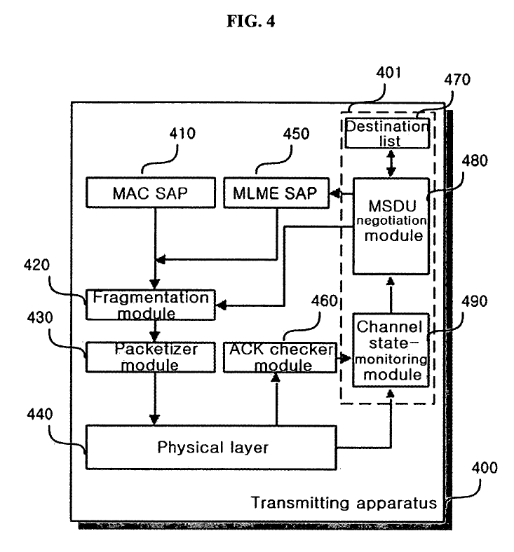

FIG. 4 is a block diagram showing a configuration of a MAC device in a transmitting apparatus according to the present invention. Referring to this figure, the transmitting apparatus comprises a MAC SAP 410, a fragmentation module 420, a packetizer module 430, a MLME SAP 450, an ACK checker module 460 and a MAC frame-managing device 401. And, the MAC frame-managing device 401 comprises a destination list 470, a MSDU negotiation module 480 and a channel state-monitoring module 490.

The MAC SAP 410 provides a service for enabling transmission/reception of data therethrough from an upper protocol layer, i.e., Logical Link Control (LLC) protocol layer, to the MAC layer. Generally, a SAP (Service Access Point) serves as a path enabling transmission/reception of data to and from the upper protocol layer.

The MLME SAP 450 provides a service of enabling the exchange of management packets with other network nodes or devices. Particularly, in the present invention, the MLME SAP 450 functions to broadcast its own maximum MSDU (MAC Service Data Unit) size by using management packets so as to determine the maximum MSDU size, and to receive the maximum MSDU size of its opponent as a unicast response to a broadcast query. As for methods of casting data, there are a broadcast method, a multicast method in addition to the unicast method. In the unicast method, there is a single node that receives data. The broadcast method considers all the nodes connected to a network as receivers, and the multicast method considers some of nodes connected to the network as receivers.

The MSDU negotiation module 480 stores the maximum MSDU size, which has been obtained by using the MLME SAP, together with a MAC address of its opponent network node in the destination list 470 and manages them. It also provides a function of controlling a fragmentation threshold according to the state of a transmitting/receiving channel. If the fragmentation threshold is too high, communication speed will be improved but the error rate increases at the same time. On the contrary, if the fragmentation threshold is too low, the error rate will decrease but communication speed will decrease at the same time. Therefore, it is necessary to determine an appropriate value for the fragmentation threshold.

The fragmentation module 420 divides a MAC frame into several frames according to the fragmentation threshold and transmits the divided frames. The packetizer module provides a function of creating a frame that conforms to the MAC frame format.

In a case where a frame with an ACK is transmitted in accordance with an ACK policy, the ACK checker module 460 determines success or failure of the transmission of the frame by checking a received ACK frame. In addition, the ACK checker module provides the determination results to the channel state-monitoring module 490.

The channel state-monitoring module 490 provides a function of monitoring the current state of a transmitting/receiving channel by comparing a failure rate of the frame transmitted from the ACK checker module 460 with the receiving signal strength of a packet received by a physical layer.

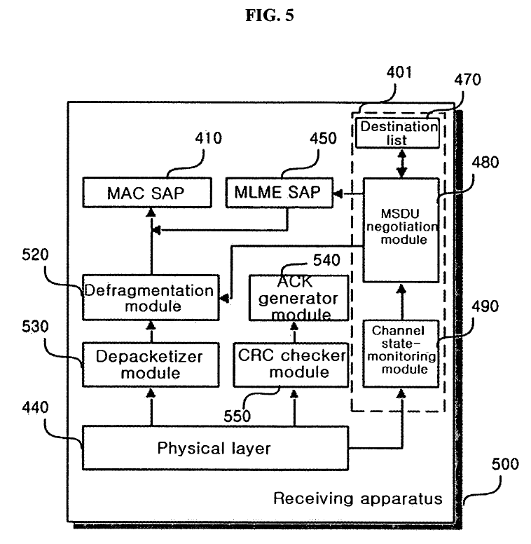

FIG. 5 is a block diagram showing a configuration of a MAC device in a receiving apparatus according to the present invention. Referring to this figure, the receiving apparatus comprises a MAC SAP 410, a depacketizer module 530, a defragmentation module 520, a MLME SAP 450, a Cyclic Redundancy Check (CRC) checker module 550, an ACK generator module 540 and the MAC frame-managing device 401. Like elements that are common to those of FIG. 4 will not be repeatedly described and elements existing only in FIG. 5 will be described below.

The depacketizer module 530 provides a function of removing the header created in a MAC Layer. The defragmentation module 520 combines the fragmented MAC frames into a single frame and transmits it to the MAC SAP 410. The CRC checker module 550 checks the CRC of a received MAC frame to determine whether there are any possible errors and provides the determination results to the ACK generator module 540. The ACK generator module 540 transmits an ACK frame based on the CRC check results according to the ACK policy.

Moreover, when the MSDU negotiation module 480 receives a management packet for the maximum MSDU size, it stores the MAC address and maximum MSDU size of a network node in the destination list and transmits its own maximum MSDU size by using a management packet.

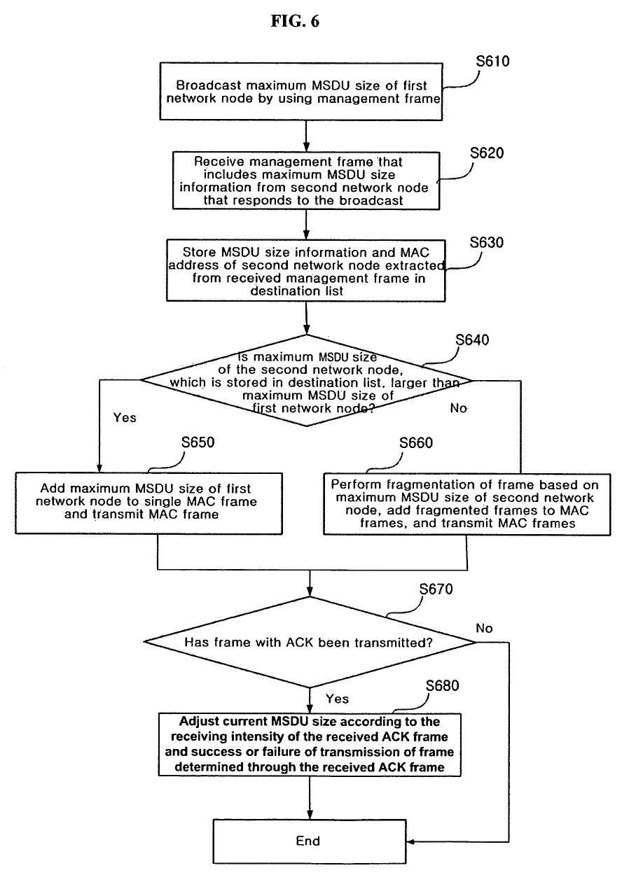

FIG. 6 is a flowchart illustrating an operation of the transmitting apparatus according to the present invention. Referring to this figure, a first network node (sending part node) broadcasts its own maximum MSDU size by using a management frame from the MSDU negotiation module when it communicates with other network nodes present in a wireless network (S610). A second network node (receiving part node) for providing the functions of the present invention among network nodes that have received the broadcast frame stores the MSDU size and MAC address of the first network node in the destination list and transmits information on its own maximum MSDU size to the first network node by using a management response frame by means of the unicast method (S620). The first network node extracts the maximum MSDU size information and MAC addresses of second network nodes from management response frames, which have been received from several devices, and stores them in the destination list (S630). At this time, the first network node does not receive any management response frames from second network nodes that do not support the functions of the present invention. In such a case, the MSDU size will become a value designated by the specification of each device.

As for the maximum MSDU size of data to be transmitted in a case where the first network node transmits data through a MAC SAP, the first network node determines MTU (Maximum Transmit Unit) as a value supported by its physical layer and then compares its own maximum MSDU size with the maximum MSDU size of a second network node present in the destination list by referring to a destination address (S640). If the maximum MSDU size of the second network node is larger than or equal to the maximum MSDU size of the first network node, the first network node adds its own maximum MSDU to a single frame and transmits the frame (S650). However, if the maximum MSDU size of the second network node is smaller than the maximum MSDU size of the first network node, the first network node performs fragmentation of a frame based on the maximum MSDU size of the second network node and transmits the fragmented frames (S660). The receiving part will receive frames up to the maximum size that can be received by the receiving part. If the received frame comprises fragmented frames, the fragmented frames will be defragmented and then sent to an upper layer.

In case of transmitting a frame including an ACK according to an ACK policy, the success or failure of the transmission of the frame will be determined by referring to the received ACK frame (S670). It is possible to adjust the size of the MSDU for the second network node according to the determination results and the receiving signal strength of the received ACK frame (S680). Therefore, the destination list stores therein the MAC address, maximum MSDU size and current MSDU of a destination network node. The current MSDU initially has the maximum MSDU size. Fragmentation will be selected based on the current MSDU of the second network node, MSDU of the first network node and the minimum value of fragmentation threshold management information base (MIB). Here, MIB refers to a formal description of a series of network objects that can be managed using Simple Network Management Protocol (SNMP) (protocol for managing a network, and monitoring and controlling network devices and their operations).

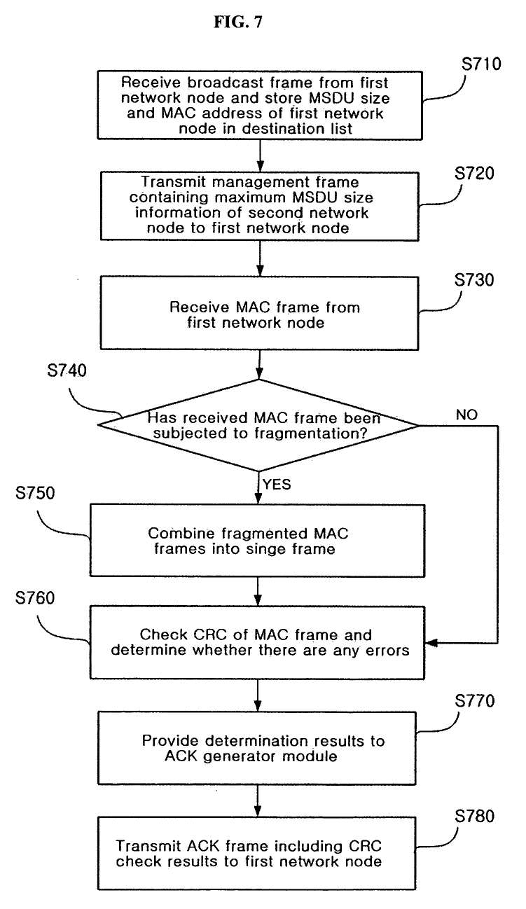

FIG. 7 is a flowchart illustrating an operation of the receiving apparatus according to the present invention. It illustrates the operation of the second network node of FIG. 6. Referring to this figure, the second network node receives the broadcast frame from the first network node and stores the maximum MSDU size and MAC address of the first network node in the destination list (S710). Then, the second network node transmits a management frame including information on its own maximum MSDU size to the first network node (S720). As described in reference to S640, S650 and S660 of FIG. 6, the first network node having received the frame transmits a frame appropriate in size depending upon result of comparison in size of its own MSDU with the maximum MSDU of the second network node, and the second network node will then receive the frame (S730). If the second network node receives the fragmented frames, it combines the fragmented frames into a single frame in the defragmentation module (S740, S750). On the contrary, if the received frame comprise no fragmented frames, there is no need for defragmentation thereof because the received frame is itself a single complete frame. In the next step, it is determined whether there are any errors by checking the CRC of the MAC frame (S760). The determination results are provided to the ACK generator module (S770) and an ACK frame including the CRC check results is transmitted to the first network node (S780).

The MAC header, the PLCP preamble, the PCLP header, the IFS (inter frame space between frames), and the ACK frame are required to transmit a single MAC frame. Therefore, in case of transmitting the MAC frame, it is more effective to transmit the MAC frame of maximum size even though the same data are transmitted. Further, in case of transmitting fragmented data, the number of fragments can be reduced and thus the respective headers, ACK and IFS can also be reduced. Therefore, there is an advantage in that throughput can be further increased.

Although the present invention has been described in connection with the exemplary embodiments of the present invention, the present invention is not limited thereto. Those skilled in the art can make various modifications and changes thereto without departing from the technical spirit and scope of the invention.

1. A Media Access Control (MAC) frame managing method comprising:
storing a maximum MAC Service Data Unit (MSDU) size and a destination MAC address of a network node obtained through a management packet;
comparing a failure rate of a frame transmitted to the network node with a signal strength of a packet received by a physical layer to output a result; and
controlling a MAC frame size by adjusting a fragmentation threshold value according to a state of a transmitting/receiving channel determined by the result.

2. A wireless-compatible MAC frame transmitting apparatus, comprising:
a Media Access Control (MAC) Service Access Point (SAP) for providing a service of transmission/reception of data between an upper protocol layer and a MAC layer;
a MAC Layer Management Entity (MLME) SAP for providing a service of transmission/reception of a packet between the apparatus and a network node;
a packetizer module for creating a MAC frame conforming to a MAC frame format by using data received from the upper protocol layer; and
a MAC Service Data Unit (MSDU) negotiation module for storing a maximum MSDU size and a MAC address of the network node obtained through the management packet and controlling a fragmentation threshold according to a state of a channel.

3. The apparatus as claimed in claim 2, further comprising a fragmentation module for dividing the MAC frame into a plurality of frames according to the fragmentation threshold and transmitting the plurality of frames.

4. The apparatus as claimed in claim 2, further comprising:
an Acknowledgement Code (ACK) checker module for, upon transmission of the MAC frame as a transmitted frame, with an ACK, determining success or failure of the transmission of the MAC frame based on a received ACK frame; and
a channel state-monitoring module for monitoring a current state of a channel by comparing a failure rate of the transmitted frame with a receiving signal strength of a packet received by a physical layer.

5. A wireless-compatible Media Access Control (MAC) frame receiving apparatus, comprising:
a depacketizer module for removing a header created in a MAC layer;
a MAC Service Access Point (SAP) for providing a service of transmission/reception of data between an upper protocol layer and the MAC layer;
a MAC Layer Management Entity (MLME) SAP for providing a service of transmission/reception of a packet between the apparatus and a network node; and
a MAC Service Data Unit (MSDU) negotiation module for determining a first MSDU size of the network node through a received management packet and transmitting information on a second MSDU size of the MAC frame receiving apparatus by using a transmitted management packet.

6. The apparatus as claimed in claim 5, further comprising:
a Cyclic Redundancy Check (CRC) checker module for checking a MAC frame received from the network node to determine whether there are any errors and generating determination results; and
an ACK generator module for receiving the determination results and creating an ACK frame.

7. The apparatus as claimed in claim 5, further comprising a defragmentation module for combining fragmented MAC frames into a single frame and transmitting the single frame to the MAC SAP.

8. A wireless-compatible Media Access Control (MAC) frame transmitting method, comprising:
broadcasting a first maximum MAC Service Data Unit (MSDU) size of a transmitting node by using a first management frame in a broadcast;
receiving a second management frame containing information on a second maximum MSDU size from a network node that responds to the broadcast;
extracting a MAC address and the second maximum MSDU size information of the network node from the second management frame and storing the MAC address and the second maximum MSDU size information of the network node in a destination list;
comparing the first maximum MSDU size of the transmitting node with the second maximum MSDU size of the network node stored in the destination list and determining which of the first and second maximum MSDU sizes is larger to output a determination result; and
transmitting a MAC frame according to the determination result, in a transmission.

9. The method as claimed in claim 8, wherein the transmitting the MAC frame comprises:
adding the first maximum MSDU of the transmitting node to a single MAC frame and transmitting the single MAC frame, if the second maximum MSDU size of the network node is larger than the first maximum MSDU of the transmitting node;
fragmenting a frame into fragmented frames based on the second maximum MSDU size of the network node, adding each of the fragmented frames to a respective one of a plurality of MAC frames and transmitting the plurality of MAC frames, if the second maximum MSDU size of the network node is smaller than the first maximum MSDU of the transmitting node.

10. The method as claimed in claim 8, further comprising the step of:
adjusting the current MSDU size according to a receiving signal strength of a received ACK frame and a success or a failure of the transmission of the MAC frame determined through the received ACK frame, if the MAC frame includes an ACK frame.

11. A Media Access Control (MAC) frame managing apparatus comprising:
means for storing a maximum MAC Service Data Unit (MSDU) size and a destination MAC address of a network node obtained through a management packet;
means for comparing a failure rate of a frame transmitted to the network node with a signal strength of a packet received by a physical layer to output a result; and
means for controlling a MAC frame size by adjusting a fragmentation threshold value according to a state of a transmitting/receiving channel determined by the result.
